(19) United States
(12) Patent Application Publication
(10) Pub. No.: US 2013/0299123 A1
(43) Pub. Date: Nov. 14, 2013

(54) Geothermal System

(71) Applicant: Joseph John Matula, Winnipeg (CA)

(72) Inventor: Joseph John Matula, Winnipeg (CA)

(21) Appl. No.: 13/823,445

(22) PCT Filed: Dec. 7, 2011
(86) PCT No.: PCT/CA2011/050753

§ 371 Date: Jul. 19, 2013

Related U.S. Application Data
(60) Provisional application No. 61/420,487, filed on Dec. 7, 2010.

(51) Int. Cl. F24J 3/08; F25D 17/00

(52) U.S. Cl. CPC F24J 3/081; F25D 17/00
USPC 165/45

(57) ABSTRACT

A geothermal system includes a first circuit including a first heat exchanger exchanging heat with a controlled space, a second circuit including a second heat exchanger exchanging heat with an outdoor temperature sink that varies seasonally, a geothermal heat exchanging assembly arranged to exchange heat between a geothermal source and the fluid in both the first and second circuits and a pumping device allowing the first circuit to function as a heat pump. The flow in both the first and second circuits is seasonally reversible to alternately heat or cool the controlled space. An expansion motor connected in series with the second circuit in communication between the second heat exchanger and the geothermal heat exchanging assembly is driven by expansion of fluid in the second circuit to function as a Rankine cycle in either seasonal direction of the flow to power the pumping device in both seasonal directions.

### FIELD OF THE INVENTION

The present invention relates to a geothermal system including a heat pump arranged to exchange heat with a geothermal fluid and a Rankine-type cycle driven by a temperature differential between the geothermal fluid and the ambient air for driving a pump component of the heat pump, and more particularly the present invention relates to geothermal system having spaced apart hot and cold wells so that the geothermal fluid can be pumped from the hot well to the cold well in a heating season and be pumped from the cold well to the hot well in the cooling season.

### BACKGROUND

Conventional geothermal systems are considered to be among the most efficient heating and cooling systems. For every unit of power consumed, it supposedly produces 3 units of heating or cooling energy equivalent. However, conventional geothermal systems have some serious drawbacks. The heating season in northern climates like Canada is so long that, especially with year round water heating it overcools the available heat sink and each year it becomes progressively harder to extract more heat from the permafrost it creates between the pipes and requires more input energy to power it each year. This frost cycling can stress and break pipes (with the subsequent environmental damage) and/or cause heaving damage to foundations.

More particularly, for every kilowatt of input energy in a conventional geothermal system we draw 2 more kilowatts of heat equivalent energy from the heat sink for a total of 3 kilowatts of usable heating energy. That is ⅓ the cost of electric resistance heating because we have drawn that much heat from the ground around the pipes. However, if the heat sink cannot recover this heat loss over summer, we would lose heating efficiency the following winter due to the depletion of the stored heat and its lower temperature at the beginning of the next heating season. Even doubling the length of the underground piping in northern climates typically only buys another few years of heat energy because typically 3 meters from the pipe the temperature of the ground does not change. Three meters underground the temperature remains constant, even after months of summer or winter weather. If bore holes are 15 meters deep and 3 meters apart, a huge area is cooled and it cannot recover heat from adjacent soil that has also been frozen. Only the top and bottom ends of the pipes can possibly recover some heat naturally over the following summer.

### SUMMARY OF THE INVENTION

According to one aspect of the invention there is provided a geothermal system comprising:

a temperature controlled space;

a primary temperature sink comprising a geothermal sink;

a secondary temperature sink arranged to have a temperature which varies seasonally with seasonal air temperature changes;

a first circuit including a first heat exchanger arranged to exchange heat between fluid in the first circuit and the controlled space;

a second circuit including a second heat exchanger arranged to exchange heat between fluid in the second circuit and the secondary temperature sink;

a geothermal heat exchanging assembly arranged to exchange heat between the primary temperature sink and the fluid in both the first and second circuits;

an expansion motor connected in series with the second circuit in communication between the second heat exchanger and the geothermal heat exchanging assembly so as to be arranged to be driven by expansion of fluid in the second circuit; and

a pumping device connected in series with the first circuit in communication between the first heat exchanger and the geothermal heat exchanging assembly so as to be arranged to pump fluid about the first circuit;

the pumping device being driven by the expansion motor.

Preferably the pumping device comprises a compressor arranged for compressing fluid in the second circuit in a vapour form from one of the first heat exchanger and the geothermal heat exchanging assembly to the other one of the first heat exchanger and the geothermal heat exchanging assembly.

More preferably, in the preferred embodiment, the working fluid in the circuits comprises only carbon dioxide, the second heat exchanger includes alternating solar evaporator and air cooled condenser circuits, the heat exchangers are closed loop, the pumping device is a compressor and other pumps are provided in the first and second circuits in the form of scroll type pumps for example. The geothermal heat exchanger assembly may receive the carbon dioxide therethrough to exchange heat directly with the ground when buried underground, or alternatively a primary conduit circulating water from the ground can be used to exchange heat with the carbon dioxide in a counter flow heat exchanger.

Preferably the primary temperature sink comprises at least one first well in the ground and at least one second well in the ground, each second well being spaced apart from the first wells. There may also be provided a primary conduit and a primary pump arranged to pump a primary fluid from one of the first and second wells for communication with the geothermal heat exchanging assembly prior to discharging the primary fluid in the other one of the first and second wells.

The primary pump of the geothermal heat sink may be arranged to be driven by the expansion motor. Alternatively, there may be provided a vapour motor connected in series with the second circuit such that the primary pump is arranged to be driven by the vapour motor. In general, the expansion motor and the pumps are positive displacement type devices.

The system may also include either a first auxiliary pump or a first expansion valve connected in series with the first circuit such that the first heat exchanger is connected in series between the first auxiliary pump or first expansion valve and the pumping device.

Similarly there may be provided a second auxiliary pump or second expansion valve connected in series with the second circuit such that the second heat exchanger is connected in series between the second auxiliary pump or second expansion valve and the expansion motor.

Preferably the second circuit is arranged such that fluid flow is seasonally reversible. In this instance second circuit may be operable in a heating mode wherein fluid in the second circuit is arranged to be condensed in the second heat exchanger and the expansion motor is arranged to be driven by expansion of the fluid in the second circuit at the geothermal heat exchanging assembly, and in a cooling mode wherein fluid in the second circuit is arranged to be condensed in the geothermal heat exchanging assembly and the expansion motor is arranged to be driven by expansion of the fluid in the second circuit at the second heat exchanger.

The dual hot and cold sinks allow for increased efficiency as the hot sink becomes hotter and the cold sink becomes colder with each passing year.

There may be provided a first primary pump arranged to pump the primary fluid from the hot well in the heating mode and a second primary pump arranged to pump the primary fluid from the cold well in the cooling mode. Each of the first and second primary pumps may be arranged to be driven by expansion of the fluid in the second circuit.

The first auxiliary pump connected in series with the first circuit may comprise a reversible pump arranged to pump the first fluid in a first direction in the heating mode and pump the first fluid in an opposing second direction in the cooling mode.

The second auxiliary pump connected in series with the second circuit may also comprise a reversible pump arranged to pump the second fluid in a first direction in the heating mode and pump the second fluid in an opposing second direction in the cooling mode.

In one embodiment the second heat exchanger comprises a supportive body, an evaporator circuit supported on a first side of the body, a condenser circuit supported on a second side of the body opposite from the first side, and a switching assembly connecting the evaporator and condenser circuits in parallel with one another in line with the second circuit such that fluid in the second circuit is arranged to be directed by the switching assembly through the evaporator circuit in the cooling mode and such that fluid in the second circuit is arranged to be directed by the switching assembly through the condenser circuit in the heating mode.

In one embodiment, the first circuit and the second circuit each comprise a closed loop arranged to circulate respective fluid therein between the respective heat exchanger and the geothermal heat exchanging assembly. In this instance the geothermal heat exchanging assembly preferably comprises a first geothermal exchanger in series with the first circuit and a second geothermal exchanger in series with the second circuit, each of the first and second geothermal exchangers being arranged to exchange heat with the primary temperature sink.

Alternatively the geothermal heat exchanging assembly comprises a common heat exchanging circuit. In this instance the first and second circuits are both connected in fluid communication with the common heat exchanging circuit in parallel with one another.

The primary temperature sink may comprise a primary conduit including a primary fluid circulating therein in a closed loop for communication between the ground and the first and second primary heat exchangers.

The system may be provided in combination with a building including an adjacent paved surface wherein the controlled space comprises an interior of the building and the secondary temperature sink comprises the adjacent paved surface.

The expansion motor may be arranged to drive an electric generator with the generator being connected to an electrical grid so as to be arranged to return generated electricity to the electrical grid.

There may be provided an electrical generator arranged to generate electricity from an input heat in which the electrical generator is coupled to the first circuit.

Preferably the second circuit is arranged to function as a Rankine cycle.

According to another aspect of the present invention there is provided a geothermal system comprising:

a temperature controlled space;

a primary temperature sink comprising a geothermal sink including a first well in the ground designated as a hot well, a second well in the ground spaced apart from the first well and designated as a cold well, a primary conduit in communication between the hot well and the cold well, and at least one primary pump arranged to pump a primary fluid through the primary conduit between the wells;

a secondary temperature sink arranged to have a temperature which varies seasonally with seasonal air temperature changes;

a first circuit including a first heat exchanger arranged to exchange heat between fluid in the first circuit and the controlled space;

a second circuit including a second heat exchanger arranged to exchange heat between fluid in the second circuit and the secondary temperature sink;

a geothermal heat exchanging assembly arranged to exchange heat between the primary conduit of the primary temperature sink and the fluid in both the first and second circuits;

an expansion motor connected in series with the second circuit in communication between the second heat exchanger and the geothermal heat exchanging assembly so as to be arranged to be driven by expansion of fluid in the second circuit;

the second circuit being operable in a heating mode wherein fluid in the second circuit is arranged to be condensed in the second heat exchanger and the expansion motor is arranged to be driven by expansion of the fluid in the second circuit at the geothermal heat exchanging assembly and in a cooling mode wherein fluid in the second circuit is arranged to be condensed in the geothermal heat exchanging assembly and the expansion motor is arranged to be driven by expansion of the fluid in the second circuit at the second heat exchanger such that fluid flow is seasonally reversible; and

a compressor connected in series with the first circuit in communication between the first heat exchanger and the geothermal heat exchanging assembly so as to be arranged to pump fluid about the first circuit, the compressor being driven by the expansion motor; and

said at least one pump being operable in the heating mode so as to pump the primary fluid from the hot well and through the geothermal heat exchanging assembly prior to discharging the primary fluid into the cold well, and being operable in the cooling mode so as to pump the primary fluid from the cold well and through the geothermal heat exchanging assembly prior to discharging the primary fluid into the hot well.

One of the greatest challenges faced in many northern climates such as Canada is the temperature extremes; however the proposed energy system will enable us to harness this bane as an endless untapped natural energy resource. This system can play a significant role in powering our energy hungry civilization into the post fossil fuels era; specifically, a heating and cooling system that may not only provide the energy required to power itself, but may provide surplus power to the electrical grid at times of greatest demand due to heating and cooling needs. All of this may be accomplished without producing any harmful emissions or depleting any more resources once the system is installed.

By using a large outdoor heat exchanger (summer evaporator, winter condenser), we not only replace the heat in the heat sink in summer, but also, using a working fluid such as carbon dioxide in the preferred embodiment, we can produce an organic Rankine cycle power to drive a heat pump, water pump, liquid working fluid pump and/or electric generator to air condition buildings and return hot water to the “hot well” for winter use and possibly even return surplus electrical power to the grid. Likewise in winter we can produce organic rankine cycle power as we heat our buildings and return cold water to the “cold well” for summer use. The more power we produce in summer, the more hot water we store in the hot well for winter use, and the more power we produce in winter, the more cold water we store in the cold well for summer use. The cooling system can be designed to be, in effect, powered by the hot summer air, and the heating system, in effect, powered by the cold winter air, as the rankine cycle reverses and the outdoor summer evaporator becomes a winter condenser. Ideally designed, the changing outdoor temperature automatically produces the needed heating and cooling at the rate needed to keep the indoor temperature at a comfortable constant. Even the day and night temperature swings can be utilized for power production if an evaporator were provided on the south side and a condenser on the north sides of an insulated wall or structure for example. By using a regulator to maintain a minimum pressure in the evaporator we can prevent freezing in the heat exchanger. Usable pressure generated at the evaporator would be minus this minimum pressure that would have to be maintained as backpressure in the system.

The cold water can be stored deeper in the aquifer and the hot water higher to minimize the necessary spacing between hot and cold sinks.

In Winnipeg, Canada the ambient temperature of underground water (draw well) is about 7 C year round. As we draw heat from the building and the condensing working fluid in a counter flow heat exchanger, we heat the water to near ambient temperature and pipe it to the “hot well”. The changing seasonal temperatures will reverse the flow of working fluid as the evaporator becomes a condenser and the condenser becomes the evaporator, so a 4 way reversing valve would not be needed. In summer, water would always flow from the cold well through the system and into the hot well, and in winter, water would flow from the hot well, through the system and into the cold well. Any heat wasted in friction or inefficiency would be recycled, as this is basically a heat recovery system.

By using the heat absorption capacity of the huge cold or frozen mass at the end of a conventional geothermal heating season to condense our working fluid during the summer, we gain free air conditioning energy and electric power as we replenish the heat in our field. If we heat the (normally 7 C field that has been depleted to 1 C) to 15 C as we produce energy over summer, we have more than replaced the heat drawn and greatly increased our winter heating efficiency and power production capacity again as well. Alternatively it may be better to maximize summer heat in the hot field and maximize winter cooling in the cold field when using carbon dioxide as the only working fluid.

Various embodiments of the invention will now be described in conjunction with the accompanying drawings in which:

### BRIEF DESCRIPTION OF THE DRAWINGS

FIG. 1 is a schematic representation of one embodiment of the geothermal system according to the present invention in which the system is shown operating in a heating mode.

FIG. 2 is a schematic representation of the system according to FIG. 1 in which the system is shown operating in a cooling mode.

FIG. 3 is a schematic representation of a second embodiment of the geothermal system according to the present invention in which the system is shown operating in a heating mode.

FIG. 4 is a schematic representation of the system according to FIG. 3 in which the system is shown operating in a cooling mode.

FIG. 5 is a perspective view of one embodiment of the geothermal heat exchanging assembly.

FIG. 6 is an elevational view of another embodiment of the geothermal heat exchanging assembly.

FIG. 7 is sectional view along the line 7-7 of FIG. 6.

FIG. 8 is a perspective view of a further embodiment of the geothermal heat exchanging assembly.

FIG. 9 is a schematic representation of an alternative embodiment of the second heat exchanger shown in a heating mode.

FIG. 10 is a schematic representation of the second heat exchanger of FIG. 9 shown in a cooling mode.

FIG. 11 is a schematic representation geoclimatic solar panel.

In the drawings like characters of reference indicate corresponding parts in the different figures.

### DETAILED DESCRIPTION

The present invention relates to an improved geothermal system generally indicated by reference numeral 10. The system 10 is well suited for use in climates having both a heating season and a cooling season. The system 10 can be used for heating and cooling a temperature controlled space 12 such as the interior of a building for example.

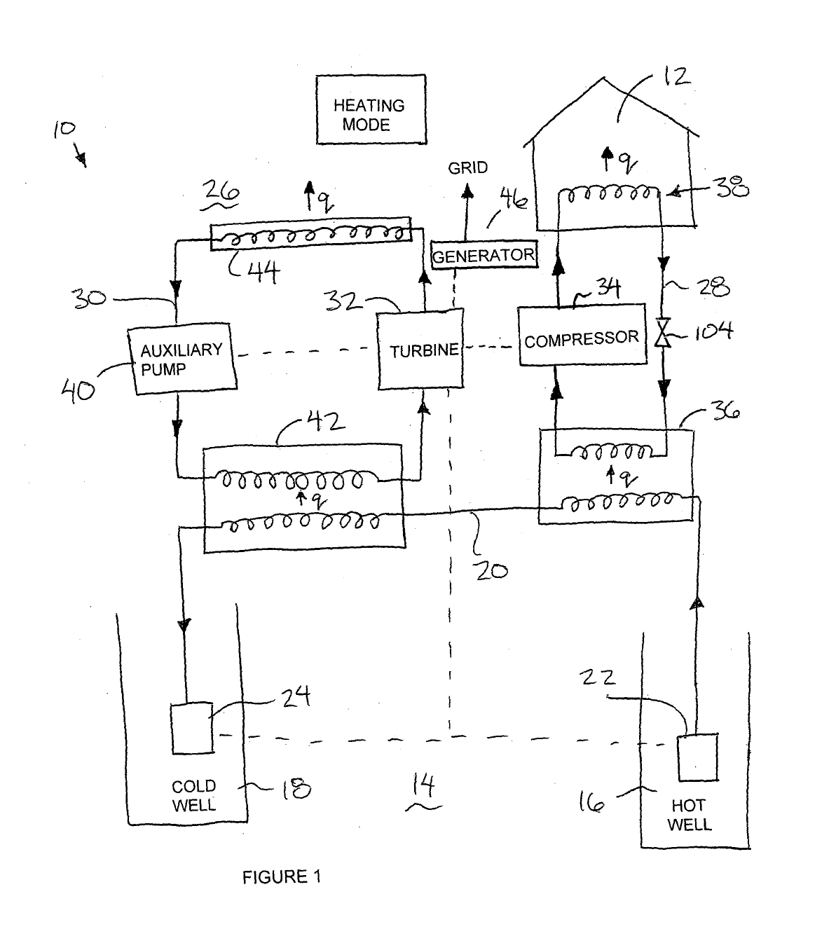

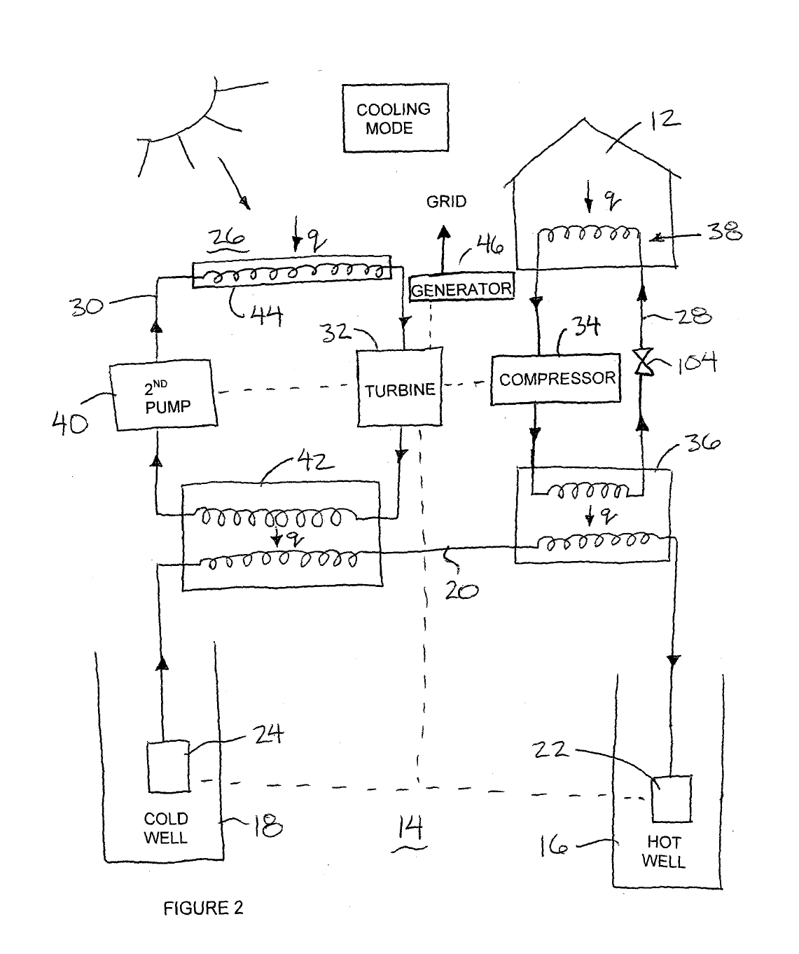

The system 10 uses a primary temperature sink 14 such as an underground or geothermal sink for supplying heat to or removing heat from the controlled spaced depending upon whether the system is operating in a heating mode shown in FIG. 1 or a cooling mode shown in FIG. 2.

In the illustrated embodiment, the primary temperature sink includes a first well in the ground designated as a hot well 16 and a second well in the ground spaced apart from the first well designated as a cold well 18. A primary conduit 20 is used together with a first primary pump 22 to pump a primary working fluid from the hot well to the cold well in the heating mode and a second primary pump 24 to pump the primary working fluid from the cold well to the hot well in the cooling mode.

The system also includes a secondary temperature sink 26 which is exposed to the ambient air so as to be arranged to have a temperature which varies with seasonal air temperature changes. In the illustrated embodiment, when the controlled space comprises the interior of a building, the secondary temperature sink may be an above ground paved surface, for example a driveway adjacent a residential building. In this instance, the secondary temperature sink also comprises a solar heat collector arranged to be heated by the sun, particularly in North American summer months corresponding to the cooling season. The asphalt driveway solar heat collector can still be a very effective heat dispersing working fluid condenser in winter if a reflective surface or a shading fence from the south side is used that still allows the north wind to effectively cool the driveway. A cover sheet that is black on one side and white on the other side could also be used that is flipped over seasonally.

Overall, the system includes a first circuit 28 operating between the controlled space and the primary temperature sink and a second circuit 30 operating between the primary temperature sink and the second temperature sink.

According to a first embodiment shown in FIGS. 1 and 2, the first circuit 28 includes a first working fluid being circulated in a closed loop therein. The first circuit 28 effectively comprises a functioning heat pump to transfer heat between the controlled space and the primary temperature sink depending upon the seasonal mode. Similarly, the second circuit 30 in the first embodiment only includes a second working fluid being circulated therein in a closed loop. The second circuit 30 effectively comprises an organic Rankine cycle arranged to generate power at an expansion motor 32 based upon the temperature differential between the primary temperature sink and the secondary temperature sink. The expansion motor may be a turbine or any other suitable motor which is driven by vapour pressure of the working fluid to produce useful work used for other components of the system. The expansion motor is in communication with the second fluid in the second circuit so as to be arranged to be driven by expansion of the second fluid. Power generated by the expansion motor 32 can be used to power various components of the system 10, for example the first primary pump 22 and the second primary pump 24 may be driven by the expansion motor.

The heat pump formed by the first circuit 28 includes a pumping device 34 to pump the first fluid in a closed loop about the first circuit. The pumping device 34 is a single pump or compressor which is reversibly connected to the loop so as to be arranged to pump the first fluid in a first direction in the heating mode and pump the first fluid in an opposing second direction in the cooling mode. The pumping device 34 is driven by power output from the expansion motor 32 of the second circuit.

The first circuit also includes a first geothermal exchanger 36 arranged to exchange heat between the first fluid and the working fluid of the primary temperature sink, and a first secondary heat exchanger 38 arranged to exchange heat between the first fluid and the controlled space.

In the heating mode, the first geothermal exchanger 36 is an evaporator for the first fluid to collect heat from the primary working fluid. The first heat exchanger 38 in the controlled space is downstream from the evaporator at the output of the pumping device 34 which acts as a compressor in this instance while the first heat exchanger 38 acts as a condenser where heat is discharged into the controlled space. The compressor 34 pumps the fluid from the first geothermal exchanger 36 to the first heat exchanger 38.

In the cooling mode, the first geothermal exchanger 36 is the condenser for the first fluid to discharge collected heat into the primary working fluid. The first heat exchanger 38 in the controlled space is downstream from the condenser in this instance such that it acts as an evaporator where heat is collected from the controlled space. The compressor 34 pumps the fluid from the first heat exchanger 38 to the first geothermal exchanger 36.

The organic Rankine cycle formed by the second circuit 30 includes a second pump 40 to pump the second fluid in a closed loop about the second circuit. The second pump assembly is a condensate pump which pumps the second fluid in a condensed form. The second pump assembly may include a vapour motor for driving the second pump when driven by the second fluid in an expanded form. Alternatively, the second pump may be connected to the expansion motor 32 for driving the second pump. In either instance, the second pump is reversibly connected to the second circuit so as to be arranged to pump the second fluid in a first direction in the heating mode and pump the second fluid in an opposing second direction in the cooling mode.

The second circuit also includes a second geothermal exchanger 42 arranged to exchange heat between the second fluid and the working fluid of the primary temperature sink, and a second heat exchanger 44 arranged to exchange heat between the second fluid and the secondary temperature sink.

In the heating mode, the second geothermal exchanger 42 is an evaporator for the second fluid to collect heat from the primary working fluid. The second heat exchanger 44 at the secondary temperature sink is downstream from the expansion motor 32 in this instance such that it acts as a condenser where heat is discharged into the air to which the secondary temperature sink is exposed. The second pump 40 pumps the fluid from the second heat exchanger 44 functioning as a condenser to the second geothermal exchanger 42 functioning as an evaporator for expanding the second fluid prior to the fluid reaching the expansion motor 32 where energy is drawn from the second fluid to produce work that the expansion motor 32 uses to power other components of the system.

In the cooling mode, the second geothermal exchanger 44 is the condenser for the second fluid to discharge collected heat into the primary working fluid. The second pump 40 pumps the second fluid from the second geothermal exchanger 44 functioning as the condenser to the second heat exchanger 42 in communication with the secondary temperature sink. The second heat exchanger thus functions as the evaporator in this instance by collected heat from the ambient air as well as collecting solar heat gained through the upper exposed surface of the secondary temperature sink.

As described above, each of the first and second circuits are arranged such that fluid flow is seasonally reversible. In the heating mode, the second fluid is condensed in the second heat exchanger and the expansion motor is driven by expansion of the second fluid in the second geothermal exchanger. Similarly, the first fluid is condensed in the first heat exchanger and expanded in the first geothermal exchanger. Also in the heating mode, the first primary pump pumps the primary fluid from the cold well for communication with the first and second geothermal exchangers prior to discharging the primary fluid into the cold well.

In the cooling mode, the second fluid is condensed in the second geothermal exchanger and the expansion motor is driven by expansion of the second fluid in the second heat exchanger. Similarly, the first fluid is condensed in the first geothermal exchanger and expanded in the first heat exchanger. Also in the cooling mode, the second primary pump 24 pumps the primary fluid from the cold well for communication with the first and second primary heat exchangers prior to discharging the primary fluid into the hot well.

In the illustrated embodiment of FIGS. 1 and 2, the first and second geothermal exchangers 36 and 42 may comprise a single common geothermal heat exchanging assembly in which the first and second closed loop circuits 28 and 30 commonly exchange heat with the common primary conduit 20 which exchanges heat with the geothermal sink.

In further arrangements, the expansion motor is arranged to drive an electric generator 46 and the generator is connected to an electrical grid so as to be arranged to return generated electricity to the electrical grid.

Excess heating is prevented in the controlled space by providing a thermostat control of the compressor 34 which then allows more heat to be directed to the second circuit for better driving the motor 32 and generating a larger net production of energy with a generator 46 for example.

In alternative embodiments, the primary temperature sink 14 comprises a primary conduit which includes the primary working fluid circulating therein in a closed loop configuration for communication between the ground and the first and second primary heat exchangers.

As described above in the first embodiment, the system 10 includes the following list of main components:

i) In one example, a typical residential well on an acreage is rated at 25 gpm or 1500 gph. 1500×10 lbs/gal×10F heat draw=150,000 BTUs/hr of available heat from the water. A typical gas furnace may be rated at 100,000 BTUs/hr. In this instance, this well could produce enough energy to power the entire home. In the preferred embodiment two wells are spaced apart so that water can be returned to the same aquifer about 50-100 meters apart; drawing from cold well and dumping into hot well in summer and drawing from hot well and dumping into cold well in winter.

ii) A low boiling point working fluid like ammonia or propane, or a mixture, with oil added to lubricate pumps, motors or expansion motors.

iii) A high volume, low pressure positive displacement well water pump or pumps driven by positive displacement vapor pressure motor. Return water discharge must be well below water level in return well to prevent aeration of the water and subsequent well overflow problems. Vapor drive is preferably because efficiency is lost by converting vapor to electric power and a vapor motor can work at variable speeds and harmlessly stall, restart or reverse without brownout. Alternatively, it may be preferably to use DC electric motors to drive well pumps due to the length of vapour line that could condense the vapour instead of driving the water pumps. With DC we can still have variable speed and reversing capability and they may be easier to electrically or electronically control.

iv) A positive displacement vapor drive liquid working fluid pump.

v) An air to working fluid outdoor heat exchanger—Acts as either winter condenser or summer vaporizer. Alternatively 2 separate units may be used for this function.

vi) A well water to working fluid heat exchanger (indoors or below frost level underground) which acts as winter vaporizer and summer condenser preferably counter flow to increase efficiency. Working vapor back pressure is controlled for maximum efficiency without allowing the water to freeze in the system.

vii) A heat pump that can be driven by either a seasonally reversing variable speed vapor pressure motor in winter or summer, or by electric motor in spring and fall when geothermal pressure generated may not be adequate; or for backup use.

viii) A vapor motor or turbine driven electric generator.

The system according to the present invention may be integrated into a conventional geothermal system by providing the necessary components of the second circuit to enhance the first circuit provided by the conventional geothermal system.

In some embodiments, instead of using an air to working fluid outdoor heat exchanger like the fan forced heating/cooling tower model, we can use a pipe embedded in an asphalt or concrete driveway or similar summer heat collecting or dissipating area that wouldn't need a fan. Preferably the solar panel could boost heat from a slope driveway to prevent vapor lock and to allow the driveway to preheat the carbon dioxide working fluid prior to additional heating in the solar panel. We could even insulate under the driveway and pipes to minimize thermal loss to the earth below. In this instance we could collect the heating/cooling effect of the huge surface area and shade it in winter to maximize the cooling effect or reflect more sunlight toward it to maximize heat collection in summer.

Another side benefit of the geoclimatic system would be that as the driveway acts as the winter working fluid condenser, there could be enough warming of the driveway to keep snow and ice clear all winter.

In another example, the system according to the present invention might be applied to a greenhouse. Greenhouses burn a lot of natural gas, but could use geothermal energy in the form of the present invention instead. Cold weather cruciferous crops like broccoli, cabbage and cauliflower need only 10 C to grow and at that temperature, insects that would harm the plants are inactive so we wouldn't need harmful pesticides as we grow premium organic produce. The greenhouse could serve as the preheat collector as it cooled the greenhouse to keep the insects out all summer. A solar heat collector or heat pump waste heat could further heat the water before it goes back to the hot well.

Some options which may be considered in relation to the various components of the system include the following:

i) Propane: a great working fluid temperature range, but is flammable and may eat HDPE or aluminum pipe. Ammonia eats copper pipe, so a commercial refrigerant may be a better option. Some plastic pipe has a metal foil liner that withstands chemicals.

ii) Galvanized steel pipe can withstand rolling 400F hot asphalt over it, but may not work with some refrigerants. Propane likes copper, but copper may be prohibitively expensive in the quantity needed. A copper lined HDPE pipe may also be suitable.

iii) Asphalt pavement is a good heat collecting medium and surface temperature can reach 60 C in the sun, but when laying it, heat will destroy plastic pipe and styrene insulation below it. Concrete could be poured over styrene and HDPE pipe and topped with asphalt or a black coating later. As the sun heats the driveway, it vaporizes the working fluid that drives the air conditioning heat pump. The hotter the weather, the higher the vapor pressure of the working fluid and the harder it drives the air conditioning heat pump and the hotter the water going into the hot well. As the sun goes down less power is produced as less cooling is needed. In winter the colder night temperatures and wind chill cool the condensing driveway pipes and condensing the working fluid faster, producing lower pressure in the driveway pipes and producing more power to drive a heat pump and sending more and colder water to the cold well. The system should largely self regulate to keep a constant indoor temperature and the thermostat would act by powering the electric generator instead of the heat pump, and return any surplus power to the grid, which would supply backup power to cover any shortfall or system failure. The system size is limited by well capacity without feedback from one well to the other causing loss of temperature differential and of course one's budget. Though the system size is limited to the heat sink capacity, economy of scale would suggest that a large system powering several homes may be more financially efficient and make more efficient use of an associated aquifer.

iv) The indoor water to working fluid heat exchanger can be a tapered pipe inside a coiled poly water pipe. Both indoor and outdoor heat exchangers need to be big enough to accommodate the vapor phase volume expansion and contraction to allow free flow to and from the motor or turbine. It can be, for example, 1¼″ at the gas end and connect to progressively smaller pipe until it is ¼″ pipe at the liquid end, allowing for an approximately 6 to 1 volume increase or decrease for example as the phase changes plus temperature expansion. The flow would simply reverse as the condenser became an evaporator. The water pipe has to be big enough to allow a constant flow regardless of the size of the pipe inside it, so it can taper to a smaller pipe at the liquid end as well.

In hot climates they will want to reverse this effect to maximize cooling by wasting heat as much as possible. In the winter months of a warmer climate they would use the hot side of the heat pump to provide primary heating to vaporize the working fluid instead of taking in more heat from the outdoor heat exchanger; thereby conserving the cold water for the next air conditioning season.

The success of the system 10 described herein depends on the ability to store a lot of heat (or cold) for a long time; maximizing heat (or cold) collection and storage and keeping the hot and cold sides far enough apart that they retain their temperature until it is most needed 6 months later in the opposite season. Since temperatures 3 meters below ground level do not change even after a long hot summer or a long cold winter, so we can expect that the correct spacing of earth between wells would separate them adequately. The problem could be 1 million gallons a month pumped from one well to the other. Water would tend to find a way to return to the source well, short circuiting the system. For this reason it may be preferable to use a closed loop system, or rather two closed loop systems with a series of bore holes in the earth and a continuous pipe connecting all holes in the series, making it one large hot side heat sink, and a second closed loop for the cold side heat sink. This would eliminate the problem of well water returning to the source well and short circuiting. Conventional closed loop geothermal systems may even be convertible to the system 10 of the present invention with the addition of a second closed loop series, a vapour drive generator and heat pump, outdoor heat exchanger, etc. If the hot loop surrounds a home, it would eliminate the problem of cold basements and could heat the home from around and even below it. By the time the heat sink cooled, the heating season would be over.

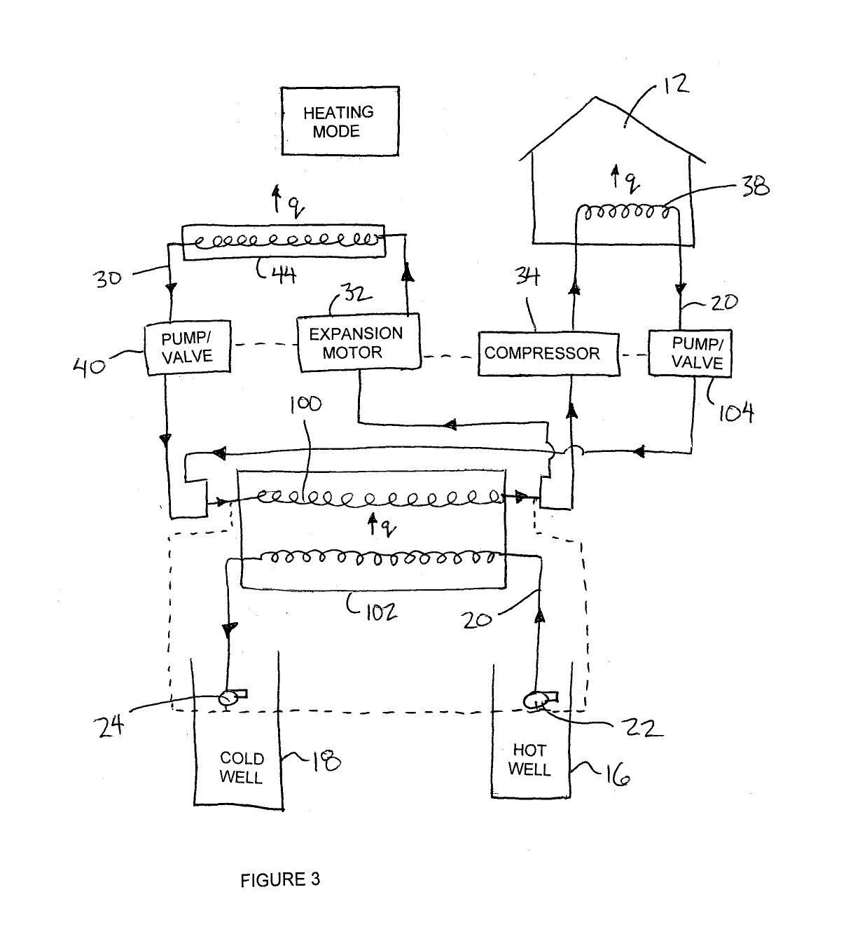

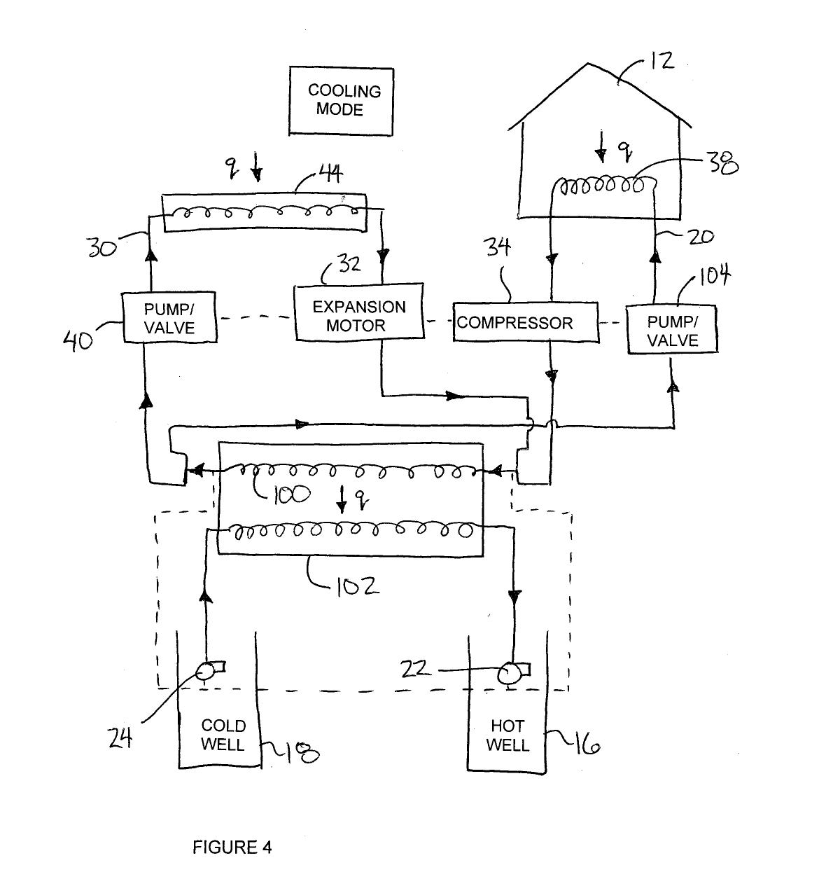

Turning now to the embodiment of FIGS. 3 and 4, the geothermal system 10 in this instance is substantially identical to the previous embodiment with regard to the inclusion of a first circuit 28 and a second circuit 30 including a first heat exchanger 38 and a second heat exchanger 44 respectively for communication with the temperature control space 12 and the secondary temperature sink 26 respectively. The second embodiment of FIGS. 3 and 4 differs from the previous embodiment in that the geothermal heat exchanging assembly in this instance instead comprises a common circuit 100 communicating with a single geothermal heat exchanger 102 to receive fluid from both the first and second circuits therethrough. Accordingly the first and second circuits are connected and parallel with one another by providing manifolds at opposing ends of the common circuit.

The first circuit in this embodiment again comprises a compressor 34 connected in series with the first heat exchanger 38 which is subsequently connected with a first auxiliary device 104 prior to joining the common circuit, such that the common circuit is in series between the auxiliary device 104 and the compressor 34 of the first circuit.

Similarly, the second circuit comprises the expansion motor 32 connected in series with the second heat exchanger 44 which is in turn connected in series with a second auxiliary device such as the pump 40 from the previous embodiment prior to joining the common circuit. The common circuit is thus also connected in series between the expansion motor 32 and the second auxiliary device 40 of the second circuit.

Depending upon the operating fluids in the circuits and the operating temperatures and pressures, the first auxiliary device 104 may comprise a condensate pump or an expansion valve. The auxiliary device 104 may also comprise a pump and an expansion valve connected in parallel so that different ones of the two devices can be used depending upon the heating or cooling mode. In this instance, the first auxiliary device would include an appropriate switching device to control which of the devices 104 operates in which mode.

Similarly the second auxiliary device 40 may also comprise a condensate pump or an expansion valve or a combination thereof connected by using a switching device between parallel connected devices to allow different components to be used depending upon the heating or cooling mode. In the instance of pumps for the first or second auxiliary device, the pumps would typically be driven by mechanical connection to the output of the expansion motor 32.

In the heating mode fluid from a first manifold of the common geothermal heat exchanger is directed to the compressor to compress the vapour prior to the vapour passing through the first heat exchanger 38 which functions as a condenser to discharge heat from the working fluid to the environment of the controlled space 12. The working fluid which is cooled or condensed in the first heat exchanger 38 is then directed through the first auxiliary device 104 to be returned to an opposing second manifold of the common circuit through the common geothermal heat exchanger. The flow through the common circuit is arranged to be opposite to the flow in the primary conduit 20 which receives a primary fluid pumped from the hot well 16 to the cold well 18 as in previous embodiments.

In the heating mode of the second circuit, the expanded and heated vapour exiting the common circuit to the compressor of the first circuit is also directed to the expansion motor 32 to capture useful work from the fluid prior to the fluid being discharged to the second heat exchanger 44 exposed to the outdoor climate which is colder than the temperature controlled space 12. The cooled fluid exiting the second heat exchanger that passes through the second auxiliary device 40 to be redirected back to the inlet manifold of the common circuit similarly to the fluid returning from the first auxiliary device 104.

As in the previous embodiment, the expansion motor 32 and the compressor 34 are reversible along with any pumps used for the first auxiliary device 104 and the second auxiliary device 40 such that the fluid flow and all circuits is reversible in the cooling mode relative to the heating mode.

In the cooling mode, fluid exiting the compressor 34 of the first circuit and the expansion motor 32 of the second circuit are joined with one another to be directed into the manifold at one end of the common circuit 100 through the geothermal heat exchanger 102. The fluid in the common circuit is cooled for being subsequently divided at the manifold at the opposing end of the common circuit where the cooled fluid is then directed to the first auxiliary device 104 of the first circuit and the second auxiliary device 40 of the second circuit respectively. Fluid from the first auxiliary device 104 is directed to the first heat exchanger 38 functioning as an evaporator to collect heat from the temperature controlled space 12 prior to being directed to the compressor 34. In the second circuit the fluid from the second auxiliary device 40 is directed to the second heat exchanger 44 to collect sufficient heat from the secondary temperature sink 26 to sufficiently expand the fluid to drive the expansion motor 32 which again drives the compressor and the pumps of the associated circuits.

Similarly to previous embodiments, excess power can be directed to a generator 46 as described above.

Also expanded fluid from one or more locations on the first or second circuits or at the manifold of the common circuit prior to entering the common geothermal heat exchanger 102 can be redirected to vapour-driven motors which drive the pumps 22 and 24 for pumping the primary fluid through the primary circuit 20 as described above in the first embodiment. The fluid exiting the vapour driven pumps can be returned downstream of the common geothermal heat exchanger 102 or at various additional points in the circuit where suitable. Use of the two pumps 22 and 24 also permit the fluid in the primary conduit to be reversed such that in the cooling mode where the flow in the common circuit is reversed relative to the heating mode, the flow in the primary conduit is also reversed to be pumped from the cold well to the hot well such that the geothermal heat exchanger 102 remains in a counter flow configuration.

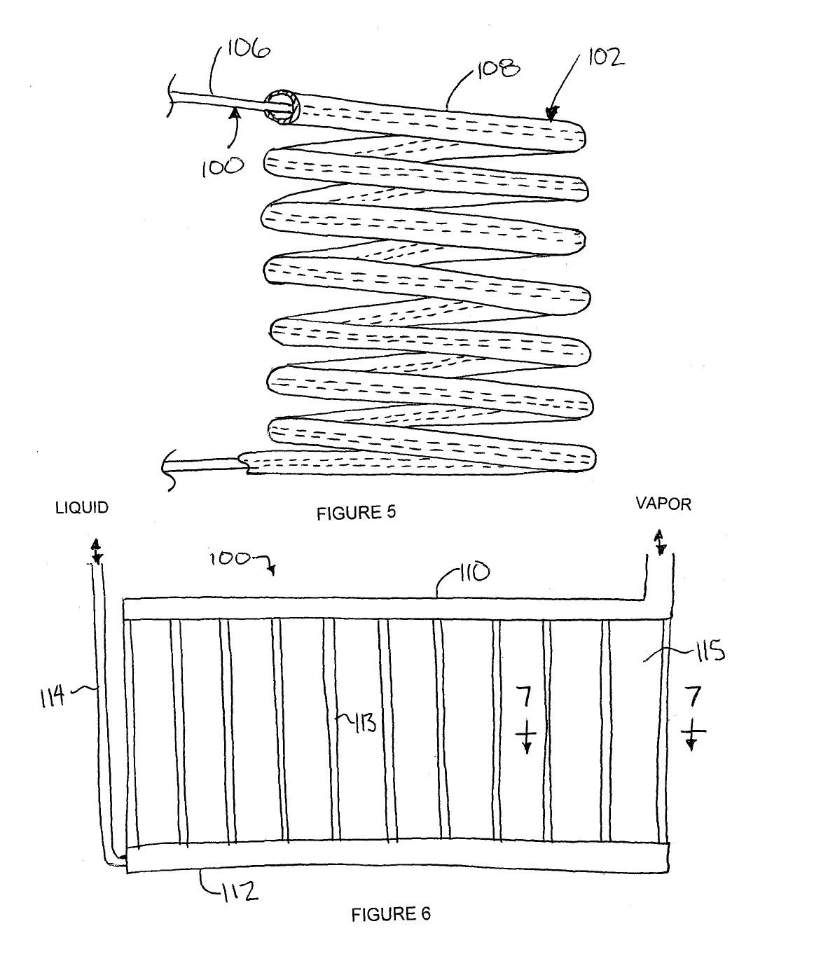

Turning now to FIG. 5, one embodiment of the geothermal heat exchanger 102 is shown in further detail. In this instance, the common circuit 100 comprises a helical tube 106 which is concentrically received within a surrounding geothermal heat exchanger tube 108 which forms a jacket surrounding the helical tube of the common circuit. In this instance, the flow in the common circuit 100 is directed through the helical tube in one direction while the primary fluid in the primary conduit 20 comprises ground water pumped between the hot and cold wells in the opposing counter flow configuration. As both flows are reversed from the heating mode to the cooling mode, the flows remain in a counter flow configuration regardless of the heating or cooling mode. One suitable working fluid includes carbon dioxide in the circuits including the common circuit 100 while the primary fluid circulating in the geothermal heat exchanger typically comprises ground water.

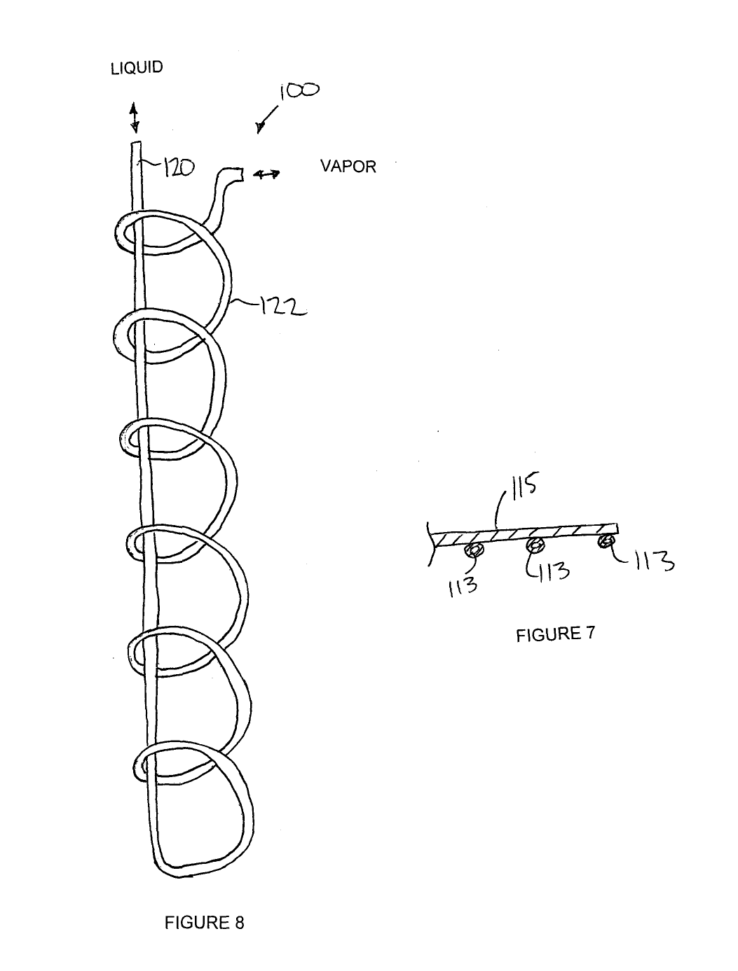

Turning now to FIGS. 6 and 7, a further embodiment of the geothermal heat exchanger is illustrated in which the common circuit 100 is arranged for direct contact with the ground. In this example a manifold structure can be assembled comprising a top vapour header 110 and a bottom liquid header 112 which span horizontally across opposing top and bottom ends of a panel structure. A plurality of vertical connector tubes 113 span in communication between the top and bottom headers at parallel and spaced apart positions within a generally common plane of the panel structure. The panel structure further includes a liquid line 114 defining a liquid port at one top corner of the panel structure in direct communication at the bottom end with the bottom liquid header 112. The top vapour header 110 includes a vapour port at the opposing top end opposite from the liquid port defined by the liquid line 114. In this instance, liquid can enter the liquid line 114 at one top corner prior to being directed downwardly through the liquid header for upward expansion into vapour towards the top vapour header prior to exiting the opposing end of the panel structure at the vapour port. In the alternative seasonal mode, vapour enters the vapour port, spans across the top vapour header 110, condenses downwardly through the connector tubes towards the bottom liquid header 112 to exit through the liquid line 114 in liquid form.

To provide additional structural support and increase the heat transfer area, a sheet metal member 115 may fully span one side of the vertical connector tubes 113 between the top and bottom headers. All of the tubes and headers are anchored to the sheet and may be collectively galvanized for being well suited to bury the panel structure in a trench in the ground. In one example, the panel structure may be 18 feet high and 35 feet long to permit galvanizing in two stages within a galvanizing tank which is 9 feet deep and 35 feet long. The galvanizing provides some structural integrity to the bonding of the components of the assembly while protecting both inner and outer surfaces from corrosion. In this instance a 30 foot deep trench of suitable length can receive the panel structure therein to permit the panel structure to be buried more than 12 feet underground by backfilling in a simple operation. The liquid port and vapour port connect to the appropriate manifolds at opposing ends of the common circuit or connect in series with other similar heat exchanging structures.

In a further embodiment as shown in FIG. 8, the geothermal heat exchanger in this instance may similarly comprise a common circuit 100 for direct communication with the ground. In this instance, the liquid line again comprises a vertical line 120 extending from a liquid port at a top end to a bottom end in connection with a vapour line 122. The vapour line 122 extends helically upward from the bottom end of the liquid line towards the top end of the liquid line to terminate at a vapour port at the top end. The common circuit 100 in this instance is similarly seasonally reversible for expanding liquid to vapour form the liquid port to the vapour port or for condensing vapour from the vapour port to the liquid port. Similarly to the previous embodiment, the common circuit in this instance is also well suited to be connected in series with other similar heat exchanging structures. In one example using conventional drilling equipment, the common circuit 100 may be arranged to have a depth of up to 40 feet with a diameter of up to 4 feet to define approximately 200 feet of linear length of common circuit having a progressively smaller diameter from the vapour port to the liquid port. The round hole would be less likely to cave in than a long deep trench.

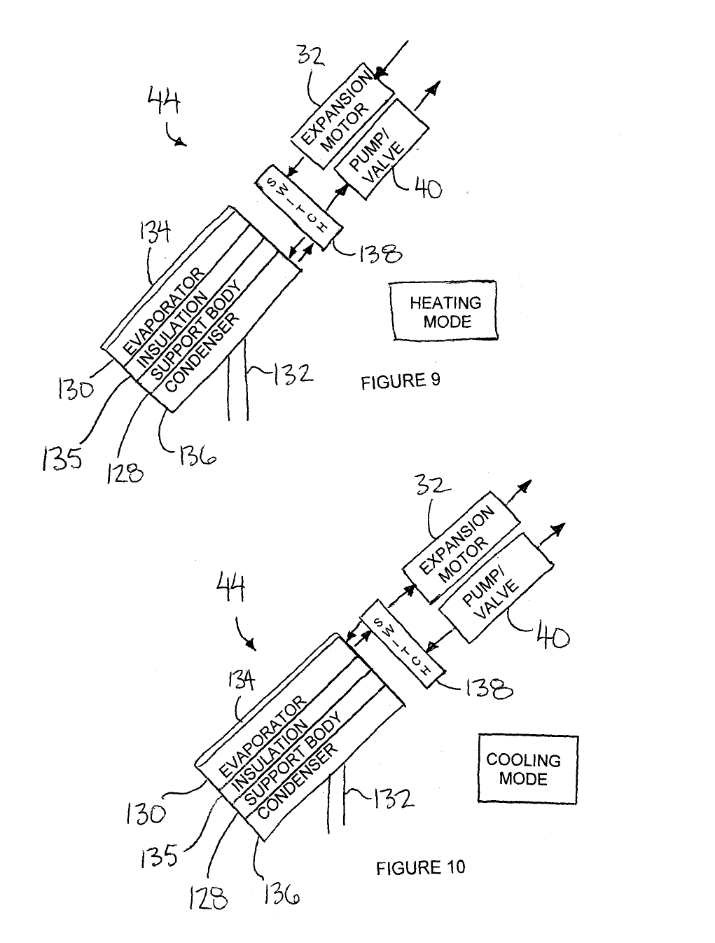

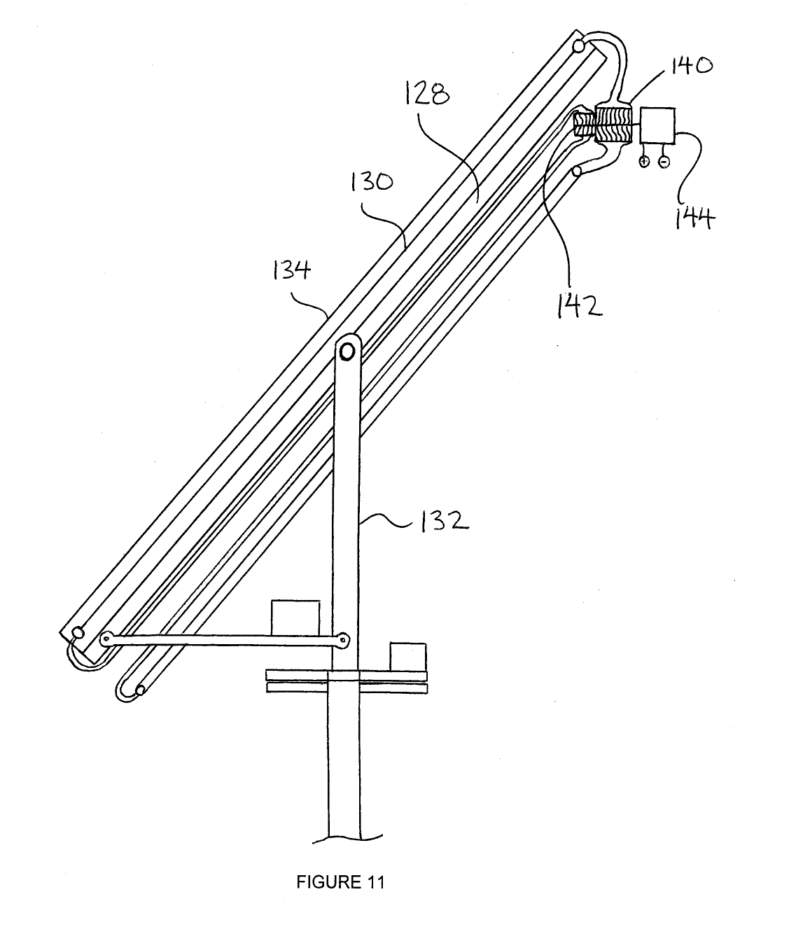

Turning now to FIGS. 9 and 10, a further embodiment of the second heat exchanger 44 is shown. In this instance, the heat exchanger 44 includes a generally planar support body 128 comprised of a plurality of parallel mounted support beams or other suitable rigid structure. An evaporation circuit 140 is supported on one side of the planar body 128 which is in turn supported on a suitable pedestal 132 such that the angular orientation of the body 128 about a vertical steering axis and about a horizontal tilting axis can be adjusted for tracking the orientation of the sun similar to various prior art solar tracking devices. The evaporation circuit 130 is supported within an insulated enclosure bound by a glass shield 134 and including insulation about the evaporation circuit and between the evaporation circuit and the body 128 in a continuous layer 135 to maximize the solar heating of the fluid in the evaporation circuit.

The heat exchanger 44 also includes a condenser circuit 136 supported on the opposing side of the planer body 128 relative to the evaporation circuit such that the condenser circuit remains shaded by the support body. The heat exchanger in this instance also includes a suitable switch assembly 138 which connects the evaporation circuit and the condenser circuit 136 with the expansion motor 32 and the auxiliary device 40 to form the circuits of FIGS. 1 through 4 respectively. In particular, the switch assembly is operable in the heating mode to receive fluid from the expansion motor to direct the fluid through the condenser circuit 136 prior to being returned to the auxiliary device 40 such that the heat exchanger 44 functions as a condenser in place of the heat exchanger 44 in the embodiment of FIG. 1 or 3. Alternatively, the switch assembly can be operated in the cooling mode in which fluid is instead directed from the auxiliary device 40 through the evaporator circuit 130 to be returned to the expansion motor 32 for operating in place of the second heat exchanger 44 in either one of the embodiments of FIG. 2 or 4.

In a further embodiment, the heat exchanger 44 of FIG. 9 or 10 may also be configured as a stand alone device by connecting the evaporator circuit 130 and the condenser circuit 136 in series with one another with an expansion motor 140 and an auxiliary pump 142 also connected in series therewith in the appropriate order to define a closed loop rankine cycle. More particularly in this instance, fluid is directed through the evaporator circuit from the auxiliary pump 142 where the expanded fluid is then directed to the expansion motor 140 to produce useful work. The fluid exiting the expansion motor is then directed through the condenser circuit to be condensed prior to being again pumped by the auxiliary pump 142 back through the evaporator circuit to continue the cycle. The pump 142 is typically directly coupled to the expansion motor 140 to be driven to rotate by the output of the expansion motor. In addition, an electrical generator 144 can also be connected to the output of the expansion motor such that excess work produced by the expansion motor 140 can be used to generate electricity. Typically, the expansion motor 140, the pump 142 and the generator 144 are all commonly supported on the support body to be located in a suitable environment by supporting on a single pedestal 132.

In some instances, part of the structural support of the support body 128 may be provided by the tubing structure of the evaporator circuit and the condenser circuit respectively. In particular, the circuits may include opposing top and bottom headers, defining frame members of the structural body for example. These circuits may also be arranged similarly to the embodiment of FIG. 6 in that parallel pipes communicate between opposing top and bottom headers which are commonly joined by sheet metal and which are commonly coated by galvanizing. Preferably rubber gaskets are provided as spacers between metal and glass components of the evaporator. A suitable working fluid is carbon dioxide.

The preferred embodiment of the present invention is a single working fluid of carbon dioxide in the configuration of the embodiments of FIGS. 3 and 4 using a solar evaporator and condenser heat exchanger 44 as in the embodiment of FIGS. 9 and 10. The carbon dioxide can be preheated to 40 degrees Celsius the previous summer. Lubricating oil can be added to the carbon dioxide. The preferred embodiment would also circulate the carbon dioxide directly into an underground heat exchanger as shown in FIG. 6 or 8 in a closed loop configuration, for example 10 to 30 feet underground.

As described above, one of the greatest challenges faced in northern climates like Canada is the temperature extremes, however this proposed energy system will enable harnessing of this bane as an endless untapped natural energy resource. This system is a heating and cooling system that will not only provide the energy required to power itself, but to provide surplus power to the electrical grid at times of greatest demand due to heating and cooling needs; all without producing any harmful emissions or depleting any more resources once the system is installed.

Geothermal was the most efficient heating and cooling system from the previous millennium, and works well in a temperate climate where heating and cooling loads are balanced. As noted above, for every unit of power consumed, it supposedly produces 3 units of heating or cooling energy equivalent. However, geothermal has some serious drawbacks. Our northern heating season is so much longer than our cooling season, especially with year round water heating it overcools the available heat sink and each year it becomes progressively harder to extract more heat from the permafrost it creates in the heat sink, and requires more input energy to power it each year. This frost cycling can stress and break pipes (with the subsequent environmental damage) and/or cause heaving damage to foundations. Even hot geothermal systems will cool the rock underground and become progressively less efficient as the “fossil heat” is depleted. By the time the system pays for itself, the heat recovery rate could be too low to be usable. These systems are typically near unstable fault lines and subject to earthquake damage as well.

By using a large outdoor heat exchanger (summer evaporator, winter condenser), we not only replace the heat in the heat sink in summer, but also, using a working fluid such as carbon dioxide, we can produce organic rankine cycle power to drive a heat pump, water pump, liquid working fluid pump and/or electric generator to air condition buildings and return hot water to the “hot well” for winter use and possibly even return surplus electrical power to the grid. Likewise in winter we can produce organic rankine cycle power as we heat our buildings and return cold water to the “cold well” for summer use. The more power we produce in summer, the more hot water we store in the hot well for winter use, and the more power we produce in winter, the more cold water we store in the cold well for summer use. We can design the cooling system to be, in effect, powered by the hot summer air, and the heating system, in effect, powered by the cold winter air, as the rankine cycle reverses and the outdoor summer evaporator becomes a winter condenser. Ideally designed, the changing outdoor temperature automatically produces the needed heating and cooling at the rate needed to keep the indoor temperature at a comfortable constant. Even the day and night temperature swings can be utilized for power production if we have an evaporator on the south side and a condenser on the north sides of an insulated wall or structure.

By using a regulator to maintain a minimum pressure in the evaporator we can prevent freezing in the heat exchanger. Usable pressure generated at the evaporator would be minus this minimum pressure that would have to be maintained as backpressure in the system.

Using a 2 well system, we can designate a “hot well” and a “cold well”, spaced for the optimal heat sink utilization of the area. For example, in Winnipeg, Canada the ambient temperature of our underground water is about 6 C year round. In summer as we draw heat from the building and the condensing working fluid in a counter flow heat exchanger, we heat the water to near or above ambient temperature and pipe it to the “hot well”. The changing seasonal temperatures will reverse the flow of working fluid as the evaporator becomes a condenser and the condenser becomes the evaporator, so a 4 way reversing valve would not be needed. In summer, water would always flow from the cold well through the system and into the hot well, and in winter, water would flow from the hot well, through the system and into the cold well. Any heat wasted in friction or inefficiency would be recycled, as this is basically a low grade waste heat recovery system. We don't need a high temperature heat source because we have cold weather and cold water to condense the working fluid. The heat energy can be stored and recycled into winter heating energy or electrical power as needed; providing the most power when the most power is needed. Unlike geothermal systems that get less efficient each year as the heat sink is depleted, a geoclimatic system would get more efficient as the hot well warmed up even more and as the cold well cooled even more each year until it reaches maximum efficiency.

As in a domestic water heater, water stratifies according to temperature. By storing the heavier cold water low in the aquifer and the hot water higher in the aquifer, we can minimize the distance we need between wells to prevent interference and the subsequent loss of efficiency.

When the required indoor temperature is reached, an inline thermostat can direct surplus power to the electric generator for local use or to share with the grid.

The galvanized pipe heat exchangers could have sheet metal spot welded to them. Then when hot dip galvanized, the zinc will weld the sheet metal to the pipes for better thermal conductivity to the surrounding earth or air.

The solar collector could also act as the roof and/or siding of the building on the east, south, and west walls, made around windows and doors, enclosed in glass and sloped for maximum solar incidence at that latitude. If the pyramid walls meet at the peak, no roof would be needed. The north roof and/or wall siding could also serve as the cold outdoor heat exchanger.

The underground water over CO2 counter flow heat exchanger could be coiled plastic pipe over coiled galvanized steel; both getting progressively larger as they coil upward, allowing for volume change as CO2 vaporizes in winter and condenses in summer in the reverse downward direction.

A waste heat recovery system would use a waste heat collector in the waste heat stream instead of a solar collector. A well to well, water over CO2, cooling exchanger could supply heat to neighbouring geothermal systems to balance the load and prevent overheating the aquifer and the resulting loss of cooling and condensing efficiency.

A sloped driveway facing south with the outdoor heat exchanger embedded in it could serve as both the summer solar collector and the winter condenser with the possible added benefit of being able to keep the snow clear all winter by thawing and sublimation as the heat escapes.

This is a waste heat recovery system as well as a geoclimatic energy production system.

East, south and west sides of the building each sloped for maximum solar incidence at that latitude, act as the siding and the roof as well as a solar collector. Colder north walls could act as the cooling heat exchanger and siding. The cold wall would of course be south in the southern hemisphere, where north would be the hot side.

In hot climates, we will want to maximize cooling, having only the north wall as the solar collector and 3 sides open for heat dissipation at night. Another option near salt water would be to generate power between the hot solar collector and an open tank of sea water. Evaporation would keep it about 10° C. below ambient, while a sloped condensing top would provide distilled water, while salt residue would provide marketable sea salt.

Spot welding sheet metal to heat exchanger pipes and then hot dip galvanizing to bond the sheet to the pipes for greater strength and thermal transfer. Sheets can then be coated with a solar absorbing finish and cased under glass to maximize heat collection.

Use of a sloped driveway or street as an outdoor heat exchanger/solar collector has a possible ice free bonus.

Storing cold water lower in the aquifer and hot water higher to minimize interference and the necessary separation distance between hot and cold wells may be desirable.

On a small lot, closed loop vertical pipe heat exchangers could be buried in narrow backhoe trenches just outside the outside foundation walls and circle the building. The heat exchangers would transfer summer heat to the soil under the building as well as around it, resulting in a warmer basement and a lower winter heat requirement. A cold circuit heat exchanger could be buried in the back yard.

Use of salt water aquifers as cold water storage below freezing for passive cooling, freezing and ice making.

Waste heat recovery can symbiotically cooperate with geothermal heating. Geothermal requires heat to replace heat loss in the heat sink while waste heat recovery requires a cold heat sink.

It may be better and easier to plan and build new communities instead of trying to retrofit old ones, particularly where waste heat is generated in cold areas. Economy of scale could make the difference between a dubious or very worthwhile project.

Large harmless geoclimatic systems would sequester tons of CO2 that would otherwise be in the atmosphere. They would replace air conditioning and refrigeration systems that are presently huge energy consumers and leaking tons of toxic, GHG producing and ozone depleting materials into the air.

Geoclimatic systems can help us wean off of carbon fuels and help us to save our planet from global warming.

Geothermal energy systems in hot geologic areas may consume the available “fossil heat” before they have even paid back the original investment. They consume a lot of water and are also typically near a geologic fault line and subject to earthquake or volcanic damage.

A thermostatically controlled valve or pressure regulator on the high pressure side would control possible freezing in the underground water over CO2 heat exchanger and control the rate of heat sink depletion after the desired temperature is reached in the controlled area.

Geoclimatic principles can be further used to produce and conserve energy almost anywhere. Internal combustion engines could use CO2 as engine coolant, using the power produced, then condensing the vapor in a rooftop heat exchanger and recycling it again.

Ventilation systems could work with geoclimatic heating by drawing warmed air from the north side cooling condenser into the air to air ventilation heat exchanger.

The system effective draws warm, stale air out through the bottom of a heat exchanger, vaporizing the liquid CO2 and absorbing the latent heat of vaporization. The fresh cold air from outside could go through the top of the same exchanger and condense the vapor that runs back down to the bottom again.

Especially in colder areas, this can be a low grade waste heat recovery system as well as a geoclimatic energy production system.

East, south and west sides of a building can be sloped for maximum solar incidence at that latitude, act as the siding and the roof as well as a solar collector. Colder north wall could act as the condensing heat exchanger and siding. The cold wall would of course be south in the southern hemisphere, where north would be the hot side.

Near salt water we could generate power between the hot solar collector and sea water, which is cooler than ambient due to evaporation. This could produce energy or make a solar powered seawater desalination system also producing marketable sea salt.

It may be better and easier to plan and build new communities instead of trying to retrofit old ones, particularly where waste heat is generated in cold areas. Existing pipes and lines would not be a problem, and economy of scale could make the difference between a marginal or a very worthwhile project,

Large harmless geoclimatic systems could sequester tons of CO2 that would otherwise be in the atmosphere. They would replace air conditioning and refrigeration systems that are presently huge energy consumers and leak tons of toxic, aquifer polluting, GHG producing and ozone depleting materials into the air.

We can use a geoclimatic system to produce and conserve energy almost anywhere on earth or even in outer space, down to −78° C. or even lower using nitrogen as the working fluid for example. Waste heat from internal combustion engines could use CO2 as engine coolant, using the power produced for propulsion, air conditioning or reefer units, or electric generation. The vapour would then pass through a rooftop condenser to complete the rankine cycle. Photovoltaic solar panels use only a narrow bandwidth of solar energy, while a glass covered, back insulated geoclimatic solar collector would use almost all of it. Some coatings boast a 96% solar heat absorption rate.

A geoclimatic heating and cooling system can greatly increase the efficiency of ventilation systems, by returning fresh air at the desired indoor temperature.

In one embodiment described above, a free standing solar panel can be made with a glass covered evaporator on the insulated sunny side of a wall or pyramid structure journal led, sloped, and rotated to track the sun, with an optional condenser on the opposite side. This panel would be more efficient than a stationary building mounted panel and could still be used independently or in conjunction with underground hot and cold thermal storage sinks.

We could make a forest of free standing geoclimatic solar panels in parks, on boulevards, or on old garbage dumps. The motor and generator could be located within the structure or underground, and series connected to other panels. The panels could be spaced and angled for maximum solar incidence without shading each other. We could even graze animals or farm between the panels or locate them between wind turbines for optimal space utilization.

Surplus power could be exported or stored as thermal energy in the aquifer and used in years with less sunshine or rainfall for hydro power.

The hot and cold thermal sinks could act as an energy storage battery, storing off peak power for use at peak demand times and making optimal use of typically hotter daytime and cooler night time temperatures.

A vertical heat exchanger just outside a building foundation or CO2 charged heat pipes in holes drilled around a foundation could bring winter temperatures down under the foundation where loss of permafrost causes foundation damage. In this case, the cold thermal sink could be around the building and the hot thermal sink could be in the back yard.

Local energy production would be less vulnerable to severe weather and ice storm or terrorism damage that could take down an entire province.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A geothermal system comprising:
a temperature controlled space;
a primary temperature sink comprising a geothermal sink;
a secondary temperature sink arranged to have a temperature which varies seasonally with seasonal air temperature changes;
a first circuit including a first heat exchanger arranged to exchange heat between fluid in the first circuit and the controlled space;
a second circuit including a second heat exchanger arranged to exchange heat between fluid in the second circuit and the secondary temperature sink;
a geothermal heat exchanging assembly arranged to exchange heat between the primary temperature sink and the fluid in both the first and second circuits;
an expansion motor connected in series with the second circuit in communication between the second heat exchanger and the geothermal heat exchanging assembly so as to be arranged to be driven by expansion of fluid in the second circuit; and
a pumping device connected in series with the first circuit in communication between the first heat exchanger and the geothermal heat exchanging assembly so as to be arranged to pump fluid about the first circuit;
the pumping device being driven by the expansion motor.

2. The system according to claim 1 wherein the pumping device comprises a compressor arranged for compressing fluid in the second circuit in a vapour form from one of the first heat exchanger and the geothermal heat exchanging assembly to the other one of the first heat exchanger and the geothermal heat exchanging assembly.

3. The system according to claim 1 wherein the primary temperature sink comprises a first well in the ground and a second well in the ground spaced apart from the first well and wherein there is provided a primary conduit and a primary pump arranged to pump a primary fluid from one of the first and second wells for communication with the geothermal heat exchanging assembly prior to discharging the primary fluid in the other one of the first and second wells.

4. The system according to claim 3 wherein the primary pump is arranged to be driven by the expansion motor.

5. The system according to claim 3 wherein there is provided a vapour motor connected in series with the second circuit and wherein the primary pump is arranged to be driven by the vapour motor.

6. The system according to claim 1 wherein there is provided a first auxiliary pump connected in series with the first circuit such that the first heat exchanger is connected in series between the first auxiliary pump and the pumping device.

7. The system according to claim 1 wherein there is provided a first expansion valve connected in series with the first circuit such that the first heat exchanger is connected in series between the first expansion valve and the pumping device.

8. The system according to claim 1 wherein there is provided a second auxiliary pump connected in series with the second circuit such that the second heat exchanger is connected in series between the second auxiliary pump and the expansion motor.

9. The system according to claim 1 wherein there is provided a second expansion valve connected in series with the first circuit such that the first heat exchanger is connected in series between the second expansion valve and the expansion motor.

10. The system according to claim 1 wherein the second circuit is arranged such that fluid flow is seasonally reversible and such that the second circuit is operable in a heating mode wherein fluid in the second circuit is arranged to be condensed in the second heat exchanger and the expansion motor is arranged to be driven by expansion of the fluid in the second circuit at the geothermal heat exchanging assembly, and in a cooling mode wherein fluid in the second circuit is arranged to be condensed in the geothermal heat exchanging assembly and the expansion motor is arranged to be driven by expansion of the fluid in the second circuit at the second heat exchanger.

11. The system according to claim 10 wherein the primary temperature sink comprises a first well in the ground designated as a hot well and a second well in the ground spaced apart from the first well designated as a cold well and wherein there is provided a primary conduit and at least one primary pump arranged to pump a primary fluid from the hot well for communication with the geothermal heat exchanging assembly prior to discharging the primary fluid into the cold well in the heating mode, and arranged to pump the primary fluid from the cold well for communication with the geothermal heat exchanging assembly prior to discharging the primary fluid into the hot well in the cooling mode.

12. The system according to claim 11 wherein there is provided a first primary pump arranged to pump the primary fluid from the hot well in the heating mode and a second primary pump arranged to pump the primary fluid from the cold well in the cooling mode, each of the first and second primary pumps being arranged to be driven by expansion of the fluid in the second circuit.

13. The system according to claim 10 wherein there is provided a first auxiliary pump connected in series with the first circuit such that the first heat exchanger is connected in series between the first auxiliary pump and the pumping device, the first auxiliary pump comprising a reversible pump arranged to pump the first fluid in a first direction in the heating mode and pump the first fluid in an opposing second direction in the cooling mode.

14. The system according to claim 10 wherein there is provided a second auxiliary pump connected in series with the second circuit such that the second heat exchanger is connected in series between the second auxiliary pump and the expansion motor, the second auxiliary pump comprising a reversible pump arranged to pump the second fluid in a first direction in the heating mode and pump the second fluid in an opposing second direction in the cooling mode.

15. The system according to claim 10 wherein the second heat exchanger comprises a supportive body, an evaporator circuit supported on a first side of the body, a condenser circuit supported on a second side of the body opposite from the first side, and a switching assembly connecting the evaporator and condenser circuits in parallel with one another in line with the second circuit such that fluid in the second circuit is arranged to be directed by the switching assembly through the evaporator circuit in the cooling mode and such that fluid in the second circuit is arranged to be directed by the switching assembly through the condenser circuit in the heating mode.

16. The system according to claim 1 wherein the first circuit and the second circuit each comprise a closed loop arranged to circulate respective fluid therein between the respective heat exchanger and the geothermal heat exchanging assembly.

17. The system according to claim 16 wherein the geothermal heat exchanging assembly comprises a first geothermal exchanger in series with the first circuit and a second geothermal exchanger in series with the second circuit, each of the first and second geothermal exchangers being arranged to exchange heat with the primary temperature sink.

18. The system according to claim 1 wherein the geothermal heat exchanging assembly comprises a common heat exchanging circuit and wherein the first and second circuits are both connected in fluid communication with the common heat exchanging circuit in parallel with one another.

19. The system according to claim 1 wherein the primary temperature sink comprises a primary conduit including a primary fluid circulating therein in a closed loop for communication between the ground and the geothermal heat exchanging assembly.

20. The system according to claim 1 in combination with a building including an adjacent paved surface wherein the controlled space comprises an interior of the building and the secondary temperature sink comprises the adjacent paved surface.

21. The system according to claim 1 wherein the expansion motor is arranged to drive an electric generator and the generator is connected to an electrical grid so as to be arranged to return generated electricity to the electrical grid.

22. The system according to claim 1 wherein there is provided an electrical generator arranged to generate electricity from an input heat, the electrical generator being coupled to the first circuit.

23. The system according to claim 1 wherein the second circuit is arranged to function as a Rankine cycle.

24. A geothermal system comprising:
a temperature controlled space;
a primary temperature sink comprising a geothermal sink including a first well in the ground designated as a hot well, a second well in the ground spaced apart from the first well and designated as a cold well, a primary conduit in communication between the hot well and the cold well, and at least one primary pump arranged to pump a primary fluid through the primary conduit between the wells;
a secondary temperature sink arranged to have a temperature which varies seasonally with seasonal air temperature changes;
a first circuit including a first heat exchanger arranged to exchange heat between fluid in the first circuit and the controlled space;
a second circuit including a second heat exchanger arranged to exchange heat between fluid in the second circuit and the secondary temperature sink;
a geothermal heat exchanging assembly arranged to exchange heat between the primary conduit of the primary temperature sink and the fluid in both the first and second circuits;
an expansion motor connected in series with the second circuit in communication between the second heat exchanger and the geothermal heat exchanging assembly so as to be arranged to be driven by expansion of fluid in the second circuit;
the second circuit being operable in a heating mode wherein fluid in the second circuit is arranged to be condensed in the second heat exchanger and the expansion motor is arranged to be driven by expansion of the fluid in the second circuit at the geothermal heat exchanging assembly and in a cooling mode wherein fluid in the second circuit is arranged to be condensed in the geothermal heat exchanging assembly and the expansion motor is arranged to be driven by expansion of the fluid in the second circuit at the second heat exchanger such that fluid flow is seasonally reversible; and
a compressor connected in series with the first circuit in communication between the first heat exchanger and the geothermal heat exchanging assembly so as to be arranged to pump fluid about the first circuit, the compressor being driven by the expansion motor; and
said at least one pump being operable in the heating mode so as to pump the primary fluid from the hot well and through the geothermal heat exchanging assembly prior to discharging the primary fluid into the cold well, and being operable in the cooling mode so as to pump the primary fluid from the cold well and through the geothermal heat exchanging assembly prior to discharging the primary fluid into the hot well.
